(19) United States
(12) Patent Application Publication
(10) Pub. No.: US 2018/0163041 A1
(43) Pub. Date: Jun. 14, 2018

(54) UNINFLAMMABLE PVDF FILM THAT IS RESISTANT TO TEARING AT LOW TEMPERATURES

(71) Applicant: Florent Abgrall, (US)

(72) Inventor: Florent Abgrall, (US)

(21) Appl. No.: 15/103,044

(22) PCT Filed: Dec. 17, 2014
(86) PCT No.: PCT/FR2014/053399

§ 371 Date: Jun. 9, 2016

(30) Foreign Application Priority Data
Dec. 18, 2013 (FR) 1362876

(51) Int. Cl. C08L 27/16; C08J 5/18; B32B 27/08; B32B 27/18; B32B 27/30

(52) U.S. Cl. CPC C08L 27/16; B32B 2419/06; B32B 27/08; B32B 27/18; B32B 27/304; C08L 2201/02; C08L 2203/16; C08L 2205/03; C08L 2207/53; C08J 2327/16; C08J 2433/12; C08J 2433/08; C08J 2483/04; B32B 2250/24; B32B 2307/3065; C08J 5/18

(57) ABSTRACT

The present invention relates to a fluorinated film possessing properties making it able to be used outside, especially in agricultural field as a greenhouse film for animals. The film according to the invention is a monolayer polymer film comprising a polyvinylidene fluoride (PVDF) matrix, at least one impact modifier, the content by weight of the impact modifier varying between 2.5% and less than 40%, and a flame-retarding agent. According to one variant embodiment, the invention relates to a multilayer film comprising at least one layer of said fluorinated film and at least one unmodified PVDF layer.

The present invention relates to a fluorinated film having properties which make it suitable for outside use, especially in the field of animal husbandry, such as films for covering dwellings or shelters for livestock. The film according to the invention comprises a polyvinylidene fluoride matrix, at least one impact modifier and a fire retardant.

In regions with a harsh climate, at least some protection should be afforded to animals, especially during cold and wet seasons. The absence of protection from the wind in particular may have harmful consequences for the health of the animals. Agricultural greenhouses make it possible to shelter livestock, by protecting them from the elements. The covering for these greenhouses is translucent and generally made of glass, but also of rigid or flexible plastic (for example polyethylene film or semi-rigid sheets of PVC), which has generally been treated to be resistant to ultraviolet radiation. This film may be reinforced to increase its tear strength.

Generally speaking, the films used for the roofs of buildings for animal husbandry must have several properties:
mechanical, such as: tear strength within a temperature range from −20° C. to +60° C., creep strength, drawability;
optical, such as partial transmission of visible light and the diffuse nature of the light transmitted;
chemical resistance, especially to ammonia-rich environments;
durability: resistance to humid heat and to the cold, resistance to UV radiation;
a high capacity for reflecting infrared radiation coming from the sun during the day and from the interior of the building at night, so as to ensure temperature stability within the building;
resistance to fire;
antifog and antidust properties.

It is known practice to use fluorinated polymers, especially based on vinylidene fluoride, to manufacture monolayer films used for the manufacture of agricultural buildings (in the sense of enclosed spaces). Monolayer films based on PVDF (polyvinylidene fluoride) or on VDF/HFP (vinylidene fluoride/hexafluoropropylene) copolymers, obtained by film blowing or by the cast film technique, have good mechanical, optical, chemical resistance and durability properties, to the extent that they are good candidates for applications in agricultural greenhouses. The tear strength of these films is, however, insufficient, above all in the extrusion direction (MD).

Document WO 2011/121228 describes multilayer fluorinated films comprising at least 3 layers, including a layer A made of a first vinylidene fluoride copolymer having a crystallization temperature TcA and a layer B made of a second vinylidene fluoride copolymer having a crystallization temperature TcB, TcA being greater than TcB, the layers A and B being alternating, the layer A being placed on the outside and the layer B being placed between two layers A. The tear strength of these films was significantly improved relative to known fluorinated films; however, it remains inadequate at low temperature.

It would therefore be desirable to have fluorinated films for application as covering and/or façade for buildings for animal husbandry which, in addition to the general features set out above, have good properties of tear strength in a temperature range extending from −20° C. to +60° C. and allow light to partially diffuse, thereby contributing to the well-being of the animals by a harmonious distribution of natural light, while having good fire resistance.

It has now been found that by modifying a polyvinylidene fluoride polymer by adding an impact modifier of core-shell type, a significant improvement is obtained in the tear strength of the film, especially at low temperature, while retaining a level of transmission in the visible region which is compatible with the use of the film as film for agricultural buildings. Moreover, the addition of a fire retardant confers good fire resistance properties which are indispensable for use as a greenhouse film for animals.

One of the subjects of the present invention consists of a monolayer film made of PVDF modified by the addition of at least one impact modifier of core-shell type and also containing a fire retardant.

Another subject of the invention relates to a multilayer film comprising at least one modified PVDF layer as described above and at least one unmodified PVDF layer, that is to say a PVDF which does not contain either an impact modifier or a fire retardant (hereinafter referred to as “PVDF layer”). According to one embodiment, this PVDF layer is situated on the outside of the multilayer film.

Another subject of the invention relates to the use of the films according to the invention as materials for covering agricultural buildings, especially as roofs and/or façades of greenhouses for animals.

Other features and advantages of the invention will become apparent upon reading the following description.

According to a first aspect, the invention relates to a monolayer polymer film comprising a polyvinylidene fluoride (PVDF) matrix, at least one impact modifier and a fire retardant, wherein the content by weight of impact modifier varies between 2.5% and less than 40%.

Although enabling the desired mechanical properties to be achieved, the addition of impact modifier to the films generally also has the consequence of rendering them inflammable. The subject of the invention therefore relates to the addition of a second fire-retardant additive, which makes it possible to restore the fire resistance of the product while retaining an improved tear strength through the presence of the impact modifiers. Several families of fire retardants may fulfil this role. By way of example, mention may be made of:
halogenated fire retardants,
phosphorus-based fire retardants, for example metal or organometallic phosphonate salts,
calcium tungstates, and
aluminum silicates.

Several of these compounds may be used simultaneously as fire retardant. The ratio of the total amount of fire retardant relative to that of impact modifier is between 1/30 and 1/1, preferentially between 1/15 and 1/7.

The thickness of the film according to the invention is between 30 and 200 microns, preferably between 80 and 150 microns (limits included).

According to one embodiment, the content of impact modifier is greater than 5% and less than or equal to 30% of the total weight of the film. Preferably, the content of impact modifier is greater than or equal to 10% and less than or equal to 30%.

According to one embodiment, the monolayer film according to the invention consists of a PVDF matrix, at least one core-shell impact modifier and a fire retardant.

The PVDF matrix consists of a PVDF homopolymer or of a copolymer prepared by copolymerization of vinylidene fluoride (VDF, CH₂═CF₂) with a fluorinated comonomer chosen from: vinyl fluoride, trifluoroethylene (VF3), chiorotrifluoroethylene (CTFE), 1,2-difluoroethylene, tetrafluoroethylene (TFE), hexafluoropropylene (HFP), perfluoro(alkyl vinyl ether)s, such as perfluoro(methyl vinyl ether) (PMVE), perfluoro(ethyl vinyl ether) (PEVE) and perfluoro(propyl vinyl ether) (PPVE), perfluoro(1,3-dioxole) and perfluoro(2,2-dimethyl-1,3-dioxole) (PDD).

According to one embodiment, said matrix consists of homopolymeric PVDF.

According to another embodiment, said matrix consists of a copolymer of VDF.

Preferably, the fluorinated comonomer is chosen from chlorotrifluoroethylene (CTFE), hexafluoropropylene (HFP), trifluoroethylene (VF3) and tetrafluoroethylene (TFE), and mixtures thereof.

The comonomer is advantageously HFP. Preferably, the copolymer only comprises VDF and HFP.

Preferably, the fluorinated copolymers are copolymers of VDF, such as VDF-HFP containing at least 50% by weight of VDF, advantageously at least 75% by weight of VDF and preferably at least 80% by weight of VDF. For example, mention may be more particularly made of the copolymers of VDF containing more than 75% of VDF and the remainder of HFP, sold by Arkema under the name Kynar Flex®.

According to one embodiment, the core-shell impact modifier is in the form of fine particles having an elastomer core (having a glass transition temperature of less than 25° C., preferably of less than 0° C., more preferably still less than −5° C., even more preferably still of less than −25° C.) and at least one thermoplastic shell (comprising at least one polymer having a glass transition temperature of greater than 25° C.). The size of the particles is generally less than a micron and is advantageously between 50 and 300 nm. By way of example of core, mention may be made of homopolymers of isoprene or butadiene, copolymers of isoprene with at most 30 mol % of a vinyl monomer and copolymers of butadiene with at most 30 mol % of a vinyl monomer. The vinyl monomer may be styrene, an alkylstyrene, acrylonitrile or an alkyl (meth)acrylate. Another core family consists of homopolymers of an alkyl (meth)acrylate and copolymers of an alkyl (meth)acrylate with at most 30 mol % of a monomer chosen from another alkyl (meth)acrylate and a vinyl monomer. The alkyl (meth)acrylate is advantageously butyl acrylate. According to one embodiment, the core of the impact modifier consists of 2-ethylhexyl acrylate, which confers enhanced properties of tear strength which are equivalent to the product based on butyl acrylate.

The core of the core-shell copolymer may be entirely or partially crosslinked. It is sufficient to add at least bifunctional monomers during the preparation of the core; these monomers may be chosen from poly(meth)acrylic esters of polyols, such as butylene glycol di(meth)acrylate and trimethylolpropane trimethacrylate. Other bifunctional monomers are for example divinylbenzene, trivinylbenzene, vinyl acrylate and vinyl methacrylate. It is also possible to crosslink the core by introducing therein, by grafting or as a comonomer during the polymerization, unsaturated functional monomers, such as unsaturated carboxylic acid anhydrides, unsaturated carboxylic acids and unsaturated epoxides. By way of example, mention may be made of maleic anhydride, (meth)acrylic acid and glycidyl methacrylate.

The shell or shells are homopolymers of styrene, an alkylstyrene or methyl methacrylate or are copolymers comprising at least 70 mol % of one of these above monomers and at least one comonomer chosen from the other above monomers, another alkyl (meth)acrylate, vinyl acetate and acrylonitrile. The shell may be functionalized by introducing therein, by grafting or as a comonomer during the polymerization, unsaturated functional monomers, such as unsaturated carboxylic acid anhydrides, unsaturated carboxylic acids and unsaturated epoxides. By way of example, mention may be made of maleic anhydride, (meth)acrylic acid and glycidyl methacrylate. The shell may be partially crosslinked.

According to one embodiment, the shell polymer consists of polystyrene or PMMA. There are also core-shell polymers having two shells, one made of polystyrene and the other, on the outside, made of PMMA.

Advantageously, the core represents, by weight, 70 to 98% of the core-shell polymer, and the shell represents 30 to 2% of the core-shell polymer.

All these impact modifiers of core-shell type are sometimes referred to as soft/hard because of the core made of elastomer. There are also other types of impact modifiers of core-shell type, such as hard/soft/hard ones, that is to say that they have, in this order, a hard core, a soft shell and a hard shell. The hard parts may consist of the polymers of the shell of the preceding soft/hard ones and the soft part may consist of the polymers of the core of the preceding soft/hard ones. Mention may be made, for example, of those consisting, in this order:
of a core made of copolymer of methyl methacrylate and ethyl acrylate,
of a shell made of copolymer of butyl acrylate and styrene,
of a shell made of copolymer of methyl methacrylate and ethyl acrylate.

There are also other types of impact modifiers of core-shell type, such as hard (the core)/soft/medium-hard ones. In comparison with the preceding ones, the difference comes from the outer “medium-hard” shell, which consists of two shells: one intermediate and the other on the outside. The intermediate shell is a copolymer of methyl methacrylate, styrene and at least one monomer chosen from alkyl acrylates, butadiene and isoprene. The outer shell is a PMMA homopolymer or copolymer. Mention may be made, for example, of those consisting, in this order:
of a core made of copolymer of methyl methacrylate and ethyl acrylate,
of a shell made of copolymer of butyl acrylate and styrene,
of a shell made of copolymer of methyl methacrylate, butyl acrylate and styrene,
of a shell made of copolymer of methyl methacrylate and ethyl acrylate.

According to a preferred embodiment, the impact modifier contains a core consisting of butylene acrylate or butylene acrylate-co-butadiene, or else 2-ethylhexyl acrylate. The shell is formed of poly(methyl methacrylate) or of copolymer of methyl methacrylate and another acrylic monomer. This concerns especially the products of the Durastrength® range from Arkema. Other acrylic impact modifiers may be used, such as the Paraloid™ EXL range from Dow, or else the Kane Ace® range from Kaneka, the acrylic-based Kane Ace® range from Kaneka.

According to another embodiment, the impact modifier contains a core made of acrylate-polysiloxane copolymer and a shell made of hard resin. In this case, the core is a material of flexible rubber type prepared by polymerization of one or more vinyl monomers in the presence of a polymer of rubber type obtained from monomers such as alkyl acrylates or alkyl methacrylates, in which the alkyl group contains from 2 to 10 carbon atoms. Polyfunctional monomers, such as divinylbenzene, ethylene glycol dimethacrylate, triallyl cyanurate or triallyl isocyanurate, can be added during the polymerization as crosslinking agents. The polymer of rubber type thus obtained is combined with a rubber containing polysiloxane. The elastomers thus prepared contain at least 20% by weight of polymer of rubber type, preferably at least 40% by weight. Examples of this type of impact modifier are rubber-based grafted copolymers prepared by copolymerization by grafting a composite rubber with at least one vinyl monomer, in which the composite rubber comprises from 5 to 95% by weight of polysiloxane-based rubber and from 5 to 95% by weight of a poly(acryl (meth)acrylate) rubber. The size of the particles of these impact modifiers varies between 0.01 and 1 micron. Preferentially, this type of impact modifier consists of a core of copolymer of polysiloxane and butyl acrylate surrounded by a shell of poly(methyl methacrylate). Products of this type are sold by Mitsubishi Rayon under the reference Metablen® S-2001.

According to another embodiment, the impact modifier is composed of a poly(organosiloxane) core and of a shell of thermoplastic resin. The organic groups of the poly(organosiloxane) cores are preferably alkyl or vinyl radicals containing between 1 and 18 carbon atoms, advantageously between 1 and 6 carbon atoms, or aryl radicals or hydrocarbons which are substituted. The poly(organosiloxane) contains one or more of these groups. The siloxanes have a variable degree of functionalization which defines the degree of crosslinking of the poly(organosiloxane). Preferentially, the mean degree of functionalization is between 2 and 3, thus forming a partially crosslinked core. The shell is formed of polymers or copolymers derived from monomers such as alkyl acrylates or methacrylates, acrylonitrile, styrene, vinylstyrene, vinyl propionate, maleimide, vinyl chloride, ethylene, butadiene, isoprene and chloroprene. Preferentially, the shell is composed of styrene or of alkyl acrylate or methacrylate, the alkyl having between 1 and 4 carbon atoms. The fraction of the core represents between 0.05 and 90% by weight of the particles, preferentially between 60 and 80% by weight. The size of the particles is between 10 and 400 nm. This impact modifier may also be in the form of a core surrounded by 2 successive shells. The description of the core and of the outer shell remains identical to that of the silicone-based impact modifiers having a single shell presented above. The intermediate shell consists of a poly(organosiloxane) other than that of the core but chosen from the same composition family. Preferentially, this type of impact modifier consists of a core of polydimethylsiloxane and of a shell of poly(methyl methacrylate). Mention may be made, by way of example, of the Genioperl® range from Wacker Silicones.

According to one embodiment, the monolayer film according to the invention comprises an additive which reflects infrared radiation. This additive may be a titanium oxide or a mixed compound, such as a nacre consisting, in its center, of mica and covered with a layer of titanium oxide. Metal alloys may also be used as infrared reflector. They contain two or more of the following elements: iron, chromium, cobalt, aluminum, manganese, antimony, zinc, titanium and magnesium. Preferentially, this alloy consists of the two elements cobalt and aluminum or is a ternary alloy of cobalt, chromium and aluminum.

According to another embodiment, the monolayer film according to the invention also comprises at least one additive chosen from:
mattifying agents,
opacifying agents,
acrylic homopolymers or copolymers,
plasticizers preferably chosen from dibutyl sebacate, dioctyl phthalate, N-(n-butyl)sulfonamide and polymeric polyesters, such as those derived from the combination of adipic, azelaic or sebacic acid and diols. Combinations of these compounds may also be used.

The films according to the invention have the particular feature of combining high cold tear strength with a fire resistance which is equivalent to that of PVDF.

According to one embodiment, the film according to the invention comprises a VDF/HFP copolymer matrix (compound A1 in the examples), an impact modifier having a poly(methyl methacrylate) shell (30%) enclosing polydimethylsiloxane cores (70%), and 2% by weight of calcium tungstate as fire retardant.

According to another embodiment, the film according to the invention comprises a PVDF homopolymer matrix, an impact modifier having a poly(methyl methacrylate) shell (30%) enclosing polydimethylsiloxane cores (70%), and 2% by weight of calcium tungstate as fire retardant.

According to another embodiment, the film according to the invention comprises a VDF/HFP copolymer matrix (compound A1 in the examples), an impact modifier containing a partially crosslinked poly(butyl acrylate) core (90% by weight) and a shell consisting of a copolymer of methyl methacrylate and ethyl acrylate (10%), and 3% of calcium tungstate as fire retardant.

According to another embodiment, the film according to the invention comprises a VDF/HFP copolymer matrix (compound A1 in the examples), an impact modifier containing a partially crosslinked poly(butyl acrylate) core (90% by weight) and a shell consisting of a copolymer of methyl methacrylate and ethyl acrylate (10%), and 2% by weight of poly(pentabromobenzyl acrylate) as fire retardant.

According to a second aspect, the invention relates to a multilayer film comprising at least one layer of the monolayer film described and at least one other layer of PVDF. “Layer of PVDF” is understood as a layer consisting of a homopolymeric PVDF or a copolymer prepared by copolymerization of vinylidene fluoride (VDF, CH₂═CF₂) with a fluorinated comonomer chosen from: vinyl fluoride, trifluoroethylene (VF3), chlorotrifluoroethylene (CTFE), 1,2-difluoroethylene, tetrafluoroethylene (TFE), hexafluoropropylene (HFP), perfluoro(alkyl vinyl ether)s, such as perfluoro(methyl vinyl ether) (PMVE), perfluoro(ethyl vinyl ether) (PEVE) and perfluoro(propyl vinyl ether) (PPVE), perfluoro(1,3-dioxole) and perfluoro(2,2-dimethyl-1,3-dioxole) (PDD).

In the case of a multilayer film, the overall thickness is between 30 and 200 microns. According to one embodiment, the multilayer film consists of a central layer of PVDF modified with a core-shell impact modifier and containing a fire retardant, and of two outer layers of PVDF. The latter two layers may have the same structure, or else they may have different structures.

The distribution of the thicknesses as a percentage of the final thickness of the structure is as follows: modified PVDF layer: 20%-95%, unmodified PVDF layer: 5%-80%, i.e. for example for a total thickness of 30 microns and a 70/30 distribution: modified PVDF layer: 21 microns, and unmodified PVDF layer: 9 microns.

According to another aspect, the invention relates to methods for preparing films described above. The PVDF/impact modifier/fire retardant mixtures are obtained by melt compounding techniques known to those skilled in the art, such as the BUSS or twin-screw technique. The films are then obtained by film blowing or by the cast film technique, these techniques advantageously making it possible to obtain very wide films. The films may be extruded at a temperature of between 200 and 280° C. The blow ratio must be between 1.2 and 4, preferably between 1.5 and 3. The draw ratio must for its part be between 2 and 15, preferably between 5 and 10.

According to another aspect, the invention relates to the use of the monolayer film or the multilayer film comprising at least one layer of said monolayer film as material for the manufacture of films for roofs and/or façades of buildings, especially agricultural buildings, such as buildings for animal husbandry. These films thus exhibit the advantage of having improved durability combined with good resistance to deformation and to fire.

The following examples illustrate the invention without limiting it.

### FORMULATIONS

The compounded products are produced according to the rules of the art on a corotating twin-screw extruder. The films are then produced by cast film extrusion at 220° C. using a flat die with a 1 mm gap, and are drawn by a small calender to adjust the thickness of the product to the desired target (100 μm).

### Materials of the Study

### Matrix:

A1: VDF/HFP copolymer having a melt flow rate (MFR) of 7 g/l 0 min (5 kg, 230° C.), a melting point (Tₘ) of 142° C. and a Young's modulus of 650 MPa at 23° C., measured according to standard ISO 178. The Tₘ was measured by DSC (differential scanning calorimetry) during a temperature rise at a rate of 10° C./min. The melt flow rate is measured according to standard ISO 1133.
A2: PVDF homopolymer with a melt flow rate of 0.14 g/10 min (5 kg, 230° C.) and a melting point of 168° C.

### Impact Modifier:

B1: Durastrength® D380 acrylic impact modifier from Arkema, in the form of core-shell particles 250 nm in diameter. 90% partially crosslinked poly(butyl acrylate) forms the core of the particles. The shell (10%) consists of copolymer of methyl methacrylate and ethyl acrylate.
B2: Durastrengtha D200 acrylic impact modifier from Arkema, formed of partially crosslinked poly(butyl acrylate) cores (70%) surrounded by shells of copolymer of methyl methacrylate and ethyl acrylate (30%).
B3: Genioperl® P52 core-shell particles from Wacker. The poly(methyl methacrylate) shells (30%) enclose polydimethylsiloxane cores (70%).

### Plasticizer:

C: Dibutyl sebacate

### Fire Retardant:

D1: FR-1025 Poly(pentabromobenzyl acrylate) from ICL
D2: Calcium tungstate in powder form from Chem-Met.

The tests carried out are as follows:
Characterization of fire resistance: the film is placed on a vertical support and has a calibrated flame applied to it according to standard UL94. The flame is placed 10 mm from the bottom end of the film and is held there for 5 s. The persistence time of the flame, the surface area burnt and also the presence of ignited drops are recorded. 5 test specimens are analyzed for each sample.
Characterization of the cold tear strength: a film 100 μm thick is supported by a frame so as to stretch it by applying a stress of 1 N to it. A 980 g conical striker is dropped from a height of 230 mm and pierces the sample. Depending on the failure profile of the film (long crack propagated in the film or localized stretching), the brittle or ductile nature of the deformation may be estimated. This test is carried out at different temperatures to estimate the ductile-brittle transition temperature of the products.

### Example 1: Cold Perforation Resistance of Reference Formulations without Fire Retardant

As illustrated by examples 1 to 7 in table 1 below, the parameter with the greatest influence on the perforation resistance of the films is the impact modifier incorporated in the formulation. The fraction by weight and the nature thereof have a direct impact on the ductile or brittle nature of the deformation after cold impact.

Comparison of examples 5 and 8 and also 7 and 9 shows that exchanging the matrix of a VDF/HFP copolymer for a PVDF homopolymer only has a limited effect on the perforation behavior of the film.

The presence of plasticizer in the mixture enables a slight improvement in the ductile behavior of the film at low temperature, but its effect remains limited, as demonstrated by the absence of enhanced properties between examples 10 and 11 and also 12 and 13. The change in nature of the impact modifier in the latter 2 examples also causes a significant change in the ductile-brittle transition.

TABLE 1

| | Matrix | | Impact modifier | | Plasticizer | | |
|---|---|---|---|---|---|---|---|
| | | Content | | Content | | Content | Ductile-brittle |
| Reference | Nature | (%) | Nature | (%) | Nature | (%) | transition (° C.) |
| 1 | A1 | 100 | — | — | — | — | 0 |
| 2 | A1 | 100 | — | — | — | — | 0 |
| 3 | A1 | 95 | B1 | 5 | — | — | −10 |
| 4 | A1 | 85 | B1 | 15 | — | — | −20 |
| 5 | A1 | 85 | B3 | 15 | — | — | −30 |
| 8 | A1 | 90 | B3 | 10 | — | — | −20 |
| 7 | A1 | 95 | B3 | 5 | — | — | −15 |
| 8 | A2 | 85 | B3 | 15 | — | — | −25 |
| 9 | A2 | 95 | B3 | 5 | — | — | −15 |
| 10 | A2 | 90 | B3 | 5 | C | 5 | −20 |
| 11 | A2 | 93.5 | B3 | 4 | C | 2.5 | −20 |
| 12 | A2 | 90 | B2 | 5 | C | 5 | −10 |
| 13 | A2 | 93.5 | B2 | 4 | C | 2.5 | −10 |

### Example 2: Fire Resistance and Retention of the Mechanical Properties

TABLE 2

| | Matrix | | Impact modifier | | Fire retardant | | | | |
|---|---|---|---|---|---|---|---|---|---|
| | | Content | | Content | | Content | Ductile-brittle | Surface area | Persistance |
| Reference | Nature | (%) | Nature | (%) | Nature | (%) | transition (° C.) | burnt (mm²) | of flame (s) |
| 1 | A1 | 100 | — | — | — | — | 0 | 924 | 0 |
| 2 | A1 | 100 | — | — | — | — | 0 | 515 | 0 |
| 3 | A1 | 95 | B1 | 5 | — | — | −10 | 1068 | 0.9 |
| 4 | A1 | 85 | B1 | 15 | — | — | −20 | 5890* | 9.7 |
| 14 | A1 | 82 | B1 | 15 | D1 | 3 | −15 | 683 | 0 |
| 15 | A1 | 83 | B1 | 15 | D2 | 2 | −20 | 870 | 0.5 |
| 5 | Al | 85 | B3 | 15 | — | — | −30 | 4200 | 12 |
| 16 | A1 | 83 | B3 | 15 | D2 | 2 | −25 | 589 | 0.4 |
| 17 | A2 | 83 | B3 | 15 | D2 | 2 | −20 | 785 | 0.5 |

*The value of 5890 mm² corresponds to the combustion of the whole sample analyzed

The results obtained are shown in table 2. These results show that adding 2% or 3% of fire retardant (that is to say, a ratio of 2/15 or 1/5 with the amount of impact modifier) to the film formulation makes it possible to restore the fire resistance of the film to a level which is equivalent to that of the pure matrix.

The intrinsic fire resistance of the films is degraded by the presence of the impact modifier particles which are dispersed in the sample, as illustrated by examples 1 to 5. The addition of specific fire retardants to the film formulation makes it possible to simultaneously obtain a high fire resistance of the film and a low ductile-brittle transition temperature at low temperature as shown by examples 14 to 17.

1. A monolayer polymer film comprising a polyvinylidene fluoride (PVDF) matrix, at least one core-shell impact modifier and a fire retardant, wherein the content by weight of impact modifier varies between 2.5% and less than 40%.

2. The film as claimed in claim 1, wherein the content by weight of impact modifier is greater than 5% and less than or equal to 30%.

3. The film as claimed in claim 1, wherein the ratio of the amount of fire retardant relative to that of impact modifier is between 1/30 and 1/1.

4. The film as claimed in claim 1, wherein the PVDF matrix consists of a PVDF homopolymer or of a copolymer prepared by copolymerization of vinylidene fluoride with a fluorinated comonomer selected from the group consisting of vinyl fluoride, trifluoroethylene, chlorotrifluoroethylene, 1,2-difluoroethylene, tetrafluoroethylene, hexafluoropropylene, perfluoro(alkyl vinyl ether)s chosen from perfluoro(methyl vinyl ether), perfluoro(ethyl vinyl ether) (PEVE) and perfluoro(propyl vinyl ether), perfluoro(1,3-dioxole) and perfluoro(2,2-dimethyl-1,3-dioxole).

5. The film as claimed in claim 1, wherein the impact modifier contains an elastomer core and at least one thermoplastic shell.

6. The film as claimed in claim 5, wherein the core is composed of poly(organosiloxane) bearing one or more radicals chosen from alkyl or vinyl radicals with from 1 to 18 carbon atoms, aryl radicals and hydrocarbons which are substituted.

7. The film as claimed in claim 5, wherein the core comprises a polymer selected from the group consisting of homopolymers of isoprene, homopolymers of butadiene, copolymers of isoprene with at most 30 mol % of a vinyl monomer, copolymers of butadiene with at most 30 mol % of a vinyl monomer, homopolymers of an alkyl (meth)acrylate, and copolymers of an alkyl (meth)acrylate with at most 30 mol % of a monomer chosen from another alkyl (meth)acrylate and a vinyl monomer, the vinyl monomer being styrene, an alkylstyrene, acrylonitrile, butadiene or isoprene.

8. The film as claimed in claim 6, wherein the shell is formed of polymers or copolymers derived from monomers selected from the group consisting of C₁₋₄ alkyl acrylates, C₁₋₄ alkyl methacrylates, acrylonitrile, styrene, vinylstyrene, vinyl propionate, maleimide, vinyl chloride, ethylene, butadiene, isoprene and chloroprene.

9. The film as claimed in claim 5, wherein said core is entirely or partially crosslinked by means of an at least one bifunctional monomer chosen from poly(meth)acrylic esters of polyols, divinylbenzene, trivinylbenzene, vinyl acrylate and vinyl methacrylate, or by means of an unsaturated functional monomer chosen from unsaturated carboxylic acid anhydrides, unsaturated carboxylic acids and unsaturated epoxides.

10. The film as claimed in claim 5, wherein the core is a material of flexible rubber combined with a rubber containing polysiloxane, said flexible rubber being prepared by polymerization of one or more vinyl monomers in the presence of a rubber polymer obtained from alkyl acrylates or alkyl methacrylates, in which the alkyl group contains from 2 to 10 carbon atoms.

11. The film as claimed in claim 5, wherein the shell or shells consist of styrene homopolymer, an alkylstyrene homopolymer, or methyl methacrylate homopolymer, or consist of copolymers comprising at least 70 mol % of styrene, alkylstyrene or methyl metacrylate, and at least one comonomer chosen from the remaining monomers, another alkyl (meth)acrylate, vinyl acetate and acrylonitrile.

12. The film as claimed in claim 1, having a thickness of between 30 and 200 microns.

13. The film as claimed in claim 1, said film comprising at least one additive selected from the group consisting of mattifying agents, opacifying agents, acrylic homopolymers, acrylic copolymers, plasticizers, titanium oxides, pearlescent pigments based on mica, pearlescent pigments based on titanium oxide, and metal alloys.

14. The film as claimed in claim 1, wherein the fire retardant is selected from halogenated fire retardants, phosphorus-based fire retardants, calcium tungstates and aluminum silicates.

15. A multilayer film comprising at least one layer of a polymer film comprising a polyvinylidene fluoride (PVDF) matrix, at least one core-shell impact modifier and a fire retardant as claimed in claim 1 and at least one layer of PVDF.

16. The multilayer film as claimed in claim 15 consisting of said polymer film comprising a polyvinylidene fluoride (PVDF) matrix, at least one core-shell impact modifier and a fire retardant as an internal layer, and two outer layers of PVDF, said outer layers having an identical or different structure.

17. The film as claimed in claim 1, wherein said film is part of a building roof, building façade, agricultural building or animal husbandry building.

18. The film as claimed in claim 3, wherein the ratio of the amount of fire retardant relative to that of impact modifier is between 1/15 and 1/7.

19. The film as claimed in claim 12, having a thickness of between 80 and 150 microns.

20. The film as claimed in claim 15, wherein said film is part of a building roof, building façade, agricultural building or husbandry building.
